(19) United States
(12) Patent Application Publication
(10) Pub. No.: US 2005/0150157 A1
(43) Pub. Date: Jul. 14, 2005

(54) Indoor and outdoor shrub, tree & plant trimming and pruning canvas drop cloth

(76) Inventors: James Joseph Molino, Holbrook, NY (US); LauraAnn Molino, Holbrook, NY (US)

Correspondence Address: James Molino, 31 Jenna Court, Holbrook, NY, 11741, US

(21) Appl. No.: 11/060,092

(22) Filed: Feb. 17, 2005

Related U.S. Application Data
(63) Continuation-in-part of application No. 10/631,429, filed on Jul. 31, 2003.

(51) Int. Cl. A01G 1/00

(52) U.S. Cl. 47/1.01 R

(57) ABSTRACT

A drop cloth having a planar body made from a canvas material, the body having an outer edge forming a square and a single slit form the outer edge leading to a hole centrally located therein forming an inner edge; the body further having all edges doubled stitched. The 1″ high light weight barrier is around the entire perimeter edges, as well as all the inner edges. The drop cloth may be simply used by wrapping the cloth around any large indoor or outdoor potted plant, shrub, flower or tree, thereafter, pruning, trimming, changing soil or transferring a plant from one pot to another; thereby permitting the drop cloth to capture and contain all the debris, and for quick and easy cleanup; and for folding the drop cloth and discarding debris in a garbage pail or bag.

### BACKGROUND OF THE INTION

1. Field of the Invention

The present invention relates generally to protect indoor flooring such as; carpet, wood floors, ceramic tile, granite, linoleum, etc. and outdoor wood decks, cement or brick patios or walkways, etc. from pruning, trimming, topsoil changes, or transferring a plant from one large pot to another. This innovation also protects expensive ground coverings, such as; mulch, gravel, stone or topsoil from trimming or pruning plants, shrubs or trees.

2. Description of Related Art

Removable landscaping tarps or ground covers have been designed for outdoor use only on shrubs and trees. For example, U.S. Pat. No. 6,090,466 issued to Kartisek illustrates a large gardening aid having a pouch and ring pulls needed for large quantities of clippings. There is no suggestion of any indoor or outdoor use on large potted plants. There also is no barrier to keep the debris from falling off the drop cloth by means of the user's foot or extraneous forces. The ring pulls, rope and pouch suggest that the tarp is used for large trimming jobs. The extra time and material needed to add the pouch and ring pulls increases the manufacturing cost.

The simple design of the instant invention avoids these costs without compromising its intended use.

U.S. Pat. No. 6,128,852 issued to Hansen illustrates a landscaping tarp, which has a flexible elastic sheathing in the center to tightly wrap around any shrub or small tree. The center also has three pairs of Velcro loop connector hooks to pull the tarp closed for carrying. A flap with two Velcro strips is used to keep the cloth closed around the shrub or a flap with two Velcro strips is used to keep the cloth closed around the shrub or tree. There is no suggestion of any indoor or outdoor use on large potted plants. There also is no barrier to keep the debris from falling off the drop cloth by means of the user's foot or extraneous forces. The time and material needed to add the sheathing material, flap and Velcro loop connectors and strips increases to the manufacturing cost. The simple design of the instant invention avoids these costs without compromising its intended use.

The Indoor and Outdoor Shrub, Tree and Plant Trimming and Pruning Canvas Drop Cloth is the most simplistic version of the prior and related art. It provides the consumer with an indoor and outdoor pruning and trimming drop cloth, which is inexpensive and affective. Indoor and Outdoor Shrub, Tree and Plant Trimming and Pruning Canvas Drop Cloth does not have any ropes, Velcro loop connectors or strips, pouches, flaps or pulling rings to keep it simple, affordable and to keep manufacturing costs down.

### SUMMARY OF THE INVENTION

The Indoor and Outdoor Shrub, Tree and Plant Trimming and Pruning Canvas Drop Cloth according to the instant invention is a canvas drop cloth, square in design with a single slit from the edge to a hole in the middle of the cloth. All edges are stitched to prevent tearing or fraying. All four sides of the perimeter edges have a 1″ high light weight barrier. The two inner edges of both slits have a 1″ high light weight barrier. The inner edges of the entire centrally located circle has a 1″ high light weight barrier. The Indoor and Outdoor Shrub, Tree and Plant Trimming and Pruning Canvas Drop Cloth provides protection to all indoor flooring and outdoor surfaces when pruning, trimming or changing topsoil of indoor or outdoor large potted plants. It also provides protection to all ground covering such as; gravel, mulch, topsoil or stones when pruning or trimming plants, shrubs or trees.

It is a further object of the invention to provide an indoor and outdoor shrub, tree and plant trimming and pruning canvas drop cloth, which captures and retains all the debris and provides a tool for quick and easy, clean up.

Further still, most importantly, another object of the invention is to provide an indoor and outdoor shrub, tree and plant trimming and pruning canvas drop cloth that is low in manufacturing costs, inexpensive for the consumer and easy to use.

Another object of the invention is to provide an indoor and outdoor shrub, tree and plant trimming and pruning canvas drop cloth that is easy to deploy and easy to store.

Another object of the invention is to provide an indoor and outdoor shrub, tree and plant trimming and pruning canvas drop cloth that is light in weight and easy to carry.

Another object of the invention is to provide an indoor and outdoor shrub, tree and plant trimming and pruning canvas drop cloth that is made of a material that can be easily cleaned with the use of a washing machine.

Another object of the invention is to provide an indoor and outdoor shrub, tree and plant trimming and pruning canvas drop cloth, which has multiple functionalities. The indoor and outdoor shrub, tree and plant trimming and pruning canvas drop cloth may be used for its intended use with plants, flowers, shrubs, trees, large indoor potted plants and outdoor potted plants, but also may be used for painting or staining or for any other purpose for which a drop cloth may be put to use. These and other objects of the present invention will become readily apparent upon further view of the following specifications and drawings.

### BRIEF DESCRIPTION OF THE DRAWINGS

FIG. 1 is an overall view of the Indoor and Outdoor Shrub, Tree and Plant Trimming and Pruning Canvas Drop Cloth, which shows the barrier along with the simple design while not compromising the function ability of its intended use;

FIG. 2 is a perspective view of the Indoor and Outdoor Shrub, Tree and Plant Trimming and Pruning Canvas Drop Cloth about the base of a large indoor potted plant, tree, or flower on an oak wood floor that is protected by the canvas drop cloth whereas, all debris is captured and contained within the seven 1″ high light weight barriers;

FIG. 3 is two completed views (3A and 3B) of the Indoor and Outdoor Shrub, Tree and Plant Trimming and Pruning Canvas Drop Cloth that has been used indoors to transfer a plant, which can also be a small tree or flower, from one large pot to another, while protecting the indoor floor whereas, all debris is captured and contained within the seven 1″ high light weight barriers;

FIG. 4 is a similar reference view of the Indoor and Outdoor Shrub, Tree and Plant Trimming and Pruning Canvas Drop Cloth showing its exterior use as being the same as FIG. 2 and FIG. 3 while protecting all wood decks, cement or brick patios or walkways whereas, all the debris is captured and contained within the seven 1″ high light weight barriers;

FIG. 5 is an illustrative view of the Indoor and Outdoor Shrub, Tree and Plant Trimming and Pruning Canvas Drop Cloth about the base of an outdoor shrub, which can also be a plant, flower, or tree that is being trimmed whereas, all debris is captured and contained within the seven 1″ high light weight barriers;

FIG. 6 Depicts the view of the Indoor and Outdoor Shrub, Tree and Plant Trimming and Pruning Canvas Drop Cloth in the first of three steps of the folding process after trimming, pruning, changing topsoil or transferring a plant from one large pot to another whereas, all debris is captured and contained within the seven 1″ high light weight barriers;

FIG. 7 is a view of the Indoor and Outdoor Shrub, Tree and Plant Trimming and Pruning Canvas Drop Cloth in the second step of the folding process, which follows FIG. 6;

FIG. 8 is a view of the Indoor and Outdoor Shrub, Tree and Plant Trimming and Pruning Canvas Drop Cloth in the third and final step of the folding process, which Follows FIG. 7;

FIG. 9 is a front view of the Indoor and Outdoor Shrub, Tree and Plant Trimming and Pruning Canvas Drop Cloth in the final step following FIG. 8, whereas, the debris is being discarded.

FIG. 10 is a cross-sectional detail view of the 1″ high light weight barrier border.

### DETAILED DESCRIPTION OF THE PREFERRED EMBODIMENTS

The present invention is directed towards a simple design of an indoor and outdoor Shrub, tree and plant trimming and pruning canvas drop cloth that wraps around any large interior or exterior potted plant, as well as most shrubs and trees. My objective in the development of this invention is to protect all interior floors and exterior surfaces while also protecting expensive ground coverings from dirt, twigs, dead leaves and all trimmings. The facts above and the goal to provide the consumer with a light weight, easy to deploy, machine washable, easy to use and very affordable product will be explained in the following embodiments.

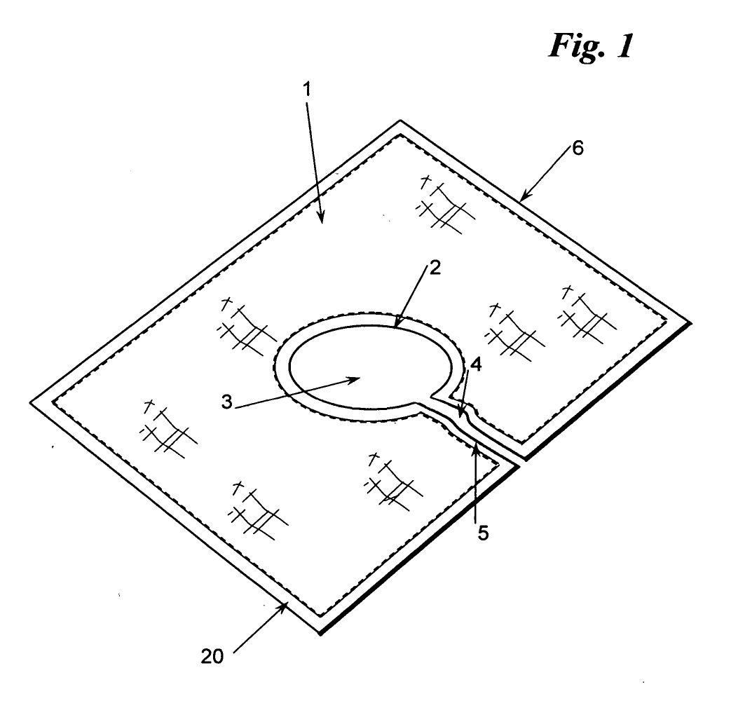

FIG. 1 shows the Indoor and Outdoor Shrub, Tree and Plant Trimming and Pruning Canvas Drop Cloth in its most simplistic design 1. The square cloth 1, or could be other shapes, has a round hole in the center 3 with a singular slit 4 from the outer edge 6 to the inner edge of the circle 2. The 1″ high×½″ wide light weight barrier border 20, or could be higher, is around the entire perimeter of the drop cloth. The inside edge 5 of both slits, has a 1″ high×½″ wide light weight barrier border 20, or could be higher. The entire centrally located circle edge 2, has a 1″ high×½″ wide light weight barrier border 20, or could be higher. The edge of both slits 5 will allow you to completely wrap the cloth 1 around any large indoor, outdoor pot or any exterior plant, tree, shrub or flower.

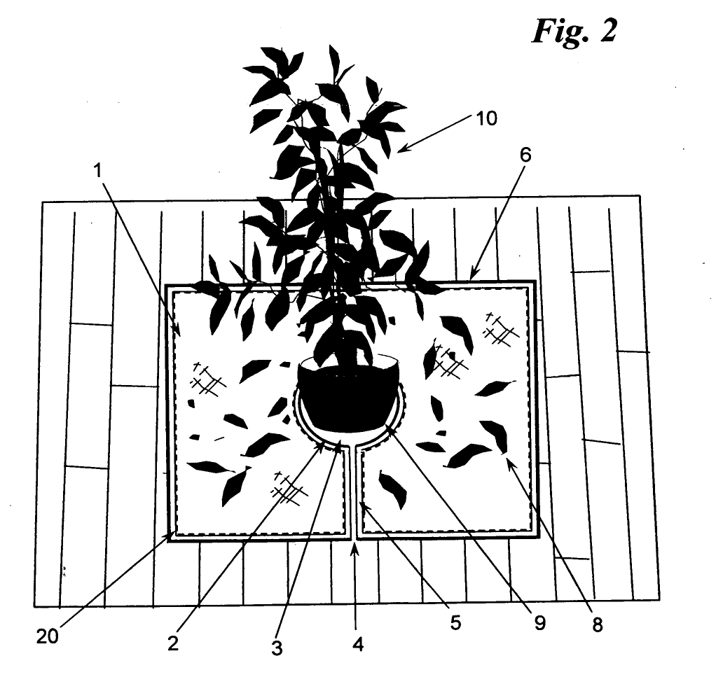

FIG. 2 shows a large indoor pot with the Indoor and Outdoor Shrub, Tree and Plant Trimming and Pruning Canvas Drop Cloth 1 wrapped around it. To close the space 4, grab the edges of both slits 5 and pull tightly around the large indoor pot 9. The large plant 10, which can be a tree or flower, sits in the large indoor pot 9 ready to be trimmed or pruned while protecting the interior floor. When the pruned or trimmed leaves fall 8, the specially designed drop cloth 1 captures all the debris without affecting the interior floor. The 1″ high light weight barrier border 20 contains the debris while pruning or trimming and during the folding process.

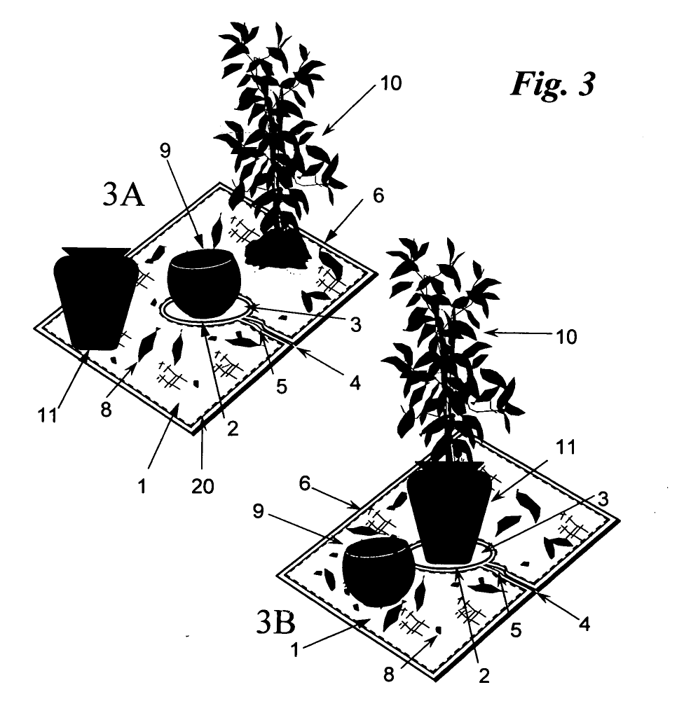

FIG. 3 shows a two stage drawing of the Indoor and Outdoor Shrub, Tree and Plant Trimming and Pruning Canvas Drop Cloth. 3A shows the Indoor and Outdoor Shrub, Tree and Plant Trimming and Pruning Canvas Drop Cloth 1 with a large empty pot 9 sitting in the center 3. The large plant 10 was removed from the large pot 9 and placed to the right of the center 3 of the drop cloth 1. The large replacement pot 11 sits to the left of the center 3 of the cloth 1.3B shows the large empty pot 9 removed and placed to the left of the center 3 of the drop cloth 1. The large replacement pot 11 is now placed in the center 3 of the drop cloth 1. The previously removed plant 10, 3A is now placed into the new pot 11, 3B located in the center 3 of the drop cloth 1, 3B. This illustration demonstrates how all indoor flooring is protected while transferring a plant, flower, or tree from one large pot to another. The 1″ high light weight barrier border 20 contains the debris while pruning, trimming and during the folding process.

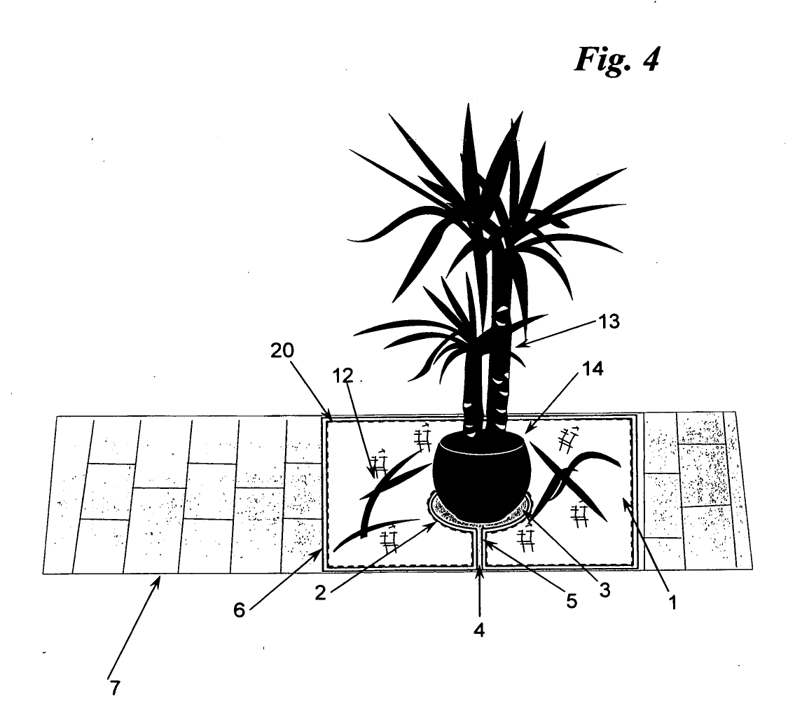

FIG. 4 shows the Indoor and Outdoor Shrub, Tree and Plant Trimming and Pruning Canvas Drop Cloth 1 sitting on an exterior brick walkway 7. To close the space 4, grab the edges of both slits 5 and pull tightly around the large outdoor pot 14. The large plant 13, which can be a tree, shrub, or flower, sits in the large outdoor pot 14 ready to be trimmed or pruned while keeping the debris off of the brick walkway 7. When the pruned or trimmed leaves 12 fall, the specially designed drop cloth 1 captures all the debris without affecting the brick walkway 7. The 1″ high light weight barrier border 20 contains the debris while pruning, trimming and during the folding process.

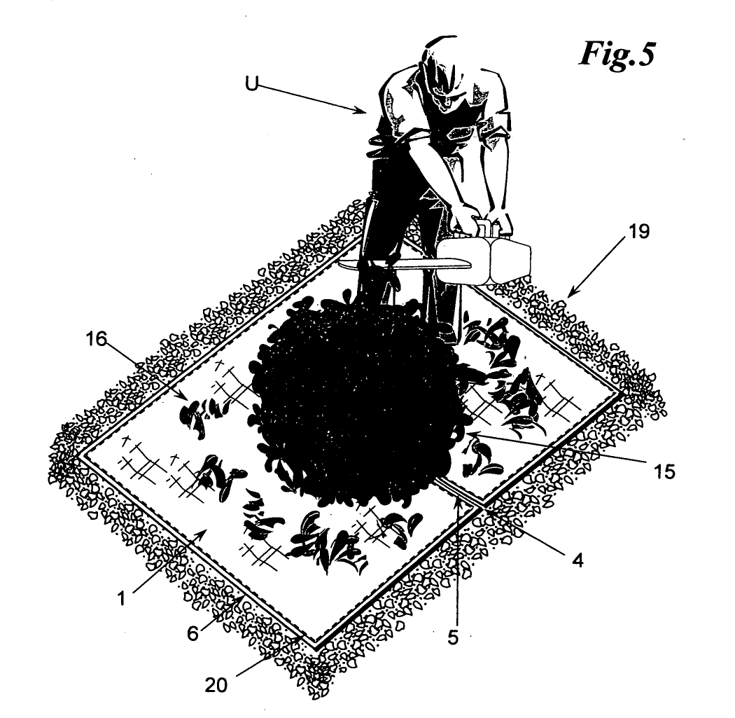

FIG. 5 shows the Indoor and Outdoor Shrub, Tree and Plant Trimming and Pruning Canvas Drop Cloth 1 wrapped around an exterior bush 15. To close the space 4, grab the edges of both slits 5 and pull tightly around the exterior bush 15 the exterior bush 15, which can be a tree, plant, or flower, sits on a bed of gravel 19, which can be mulch, stones, topsoil or grass, while a user U is trimming or pruning the bush 15. When the pruned or trimmed leaves fall 16, the specially designed drop cloth 1 captures all the debris and the 1″ high light weight barrier border 20 contains the debris to avoid mixing in with the gravel 19.

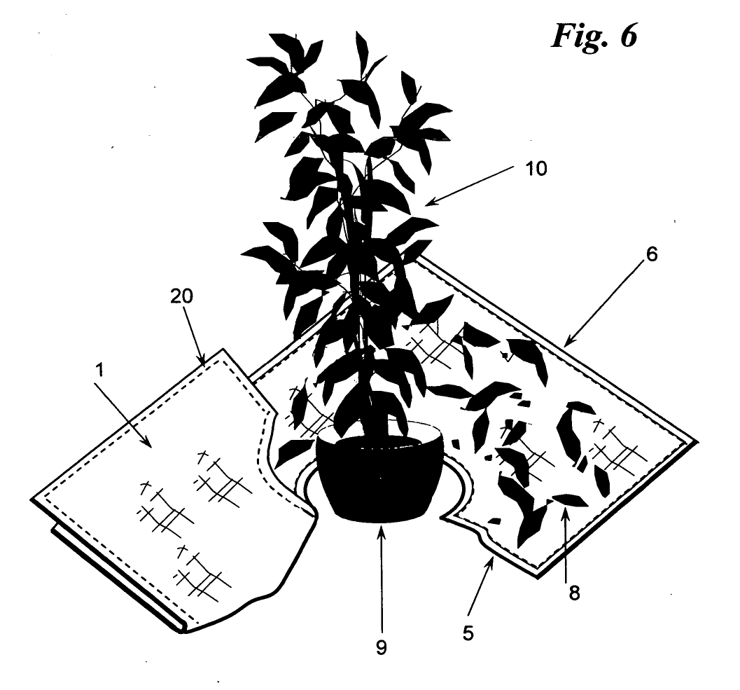

FIG. 6 shows the Indoor and Outdoor Shrub, Tree and Plant Trimming and Pruning Canvas Drop Cloth 1 wrapped around a large interior potted plant 9 and 10, which can be an interior or exterior shrub, tree, or flower. FIG. 6 also shows the first step of the folding process after pruning, trimming changing topsoil, transferring plant, tree or flower from one large pot to another. Grab the left side edge 6 of the drop cloth 1, and fold towards the back of the cloth and gently place down over the fallen debris 8. The debris 8 is now secured between the top and bottom of the left side of the canvas drop cloth 1. The 1″ high light weight barrier border 20 prevents the debris from falling off of the cloth.

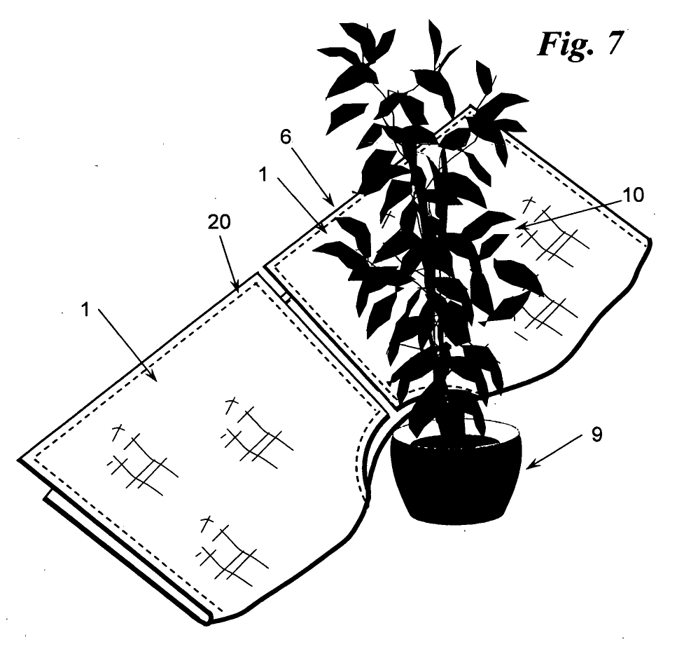

FIG. 7 shows the Indoor and Outdoor, Shrub, Tree and Plant Trimming and Pruning Canvas Drop Cloth 1 partially folded around a large interior potted plant 9 and 10, which can be an interior and exterior shrub, tree, or flower. FIG. 7 also shows the second step of the folding process after pruning, trimming, changing topsoil or transferring a plant, tree or flower from one large pot to another. Following FIG. 6, grab the right side edge 6 of FIG. 7 of the drop cloth 1, and fold towards the back of the cloth and gently place down over the fallen debris. The debris is now secured between the top and the bottom of both sides of the canvas drop cloth 1. The 1″ high light weight barrier border 20 prevents the debris from falling off of the cloth.

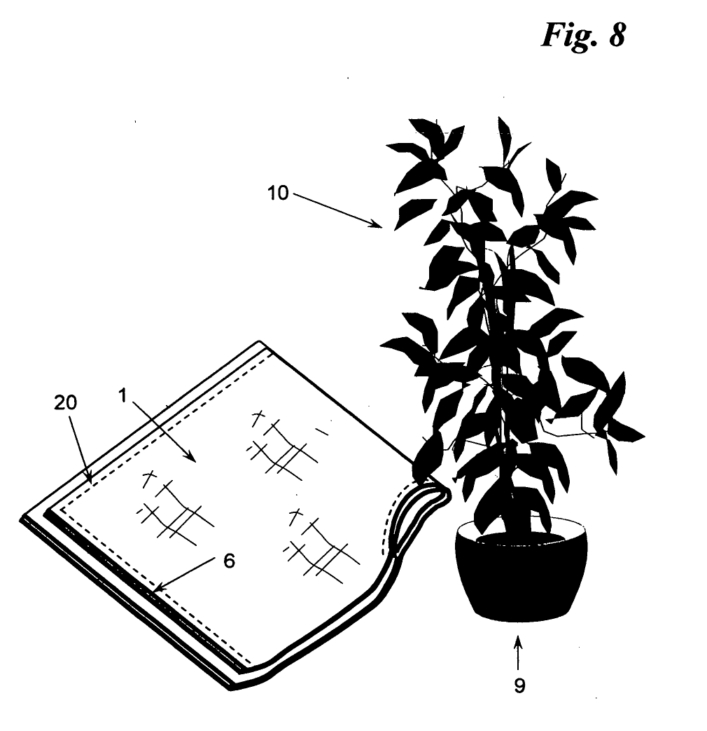

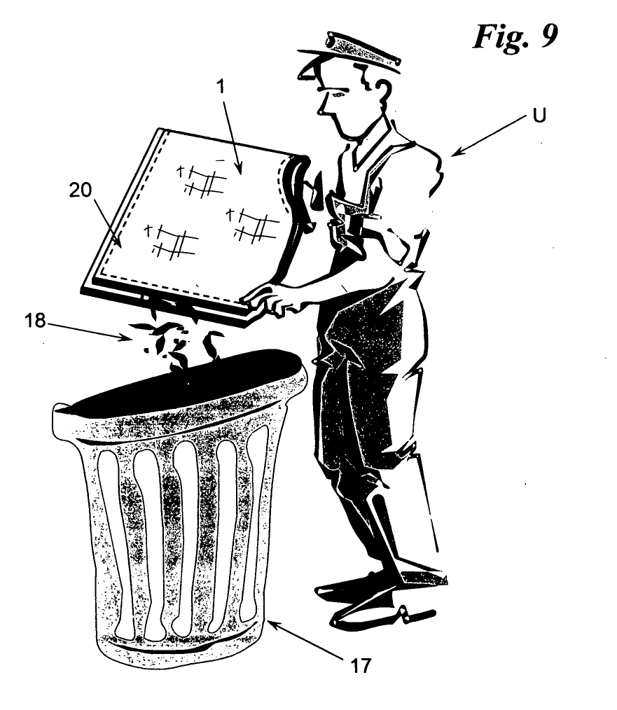

FIG. 8 shows the Indoor and Outdoor Shrub, Tree and Plant Trimming and Pruning Canvas Drop Cloth 1 in its final folding stage by the large interior potted plant 9 and 10, which can be an interior or exterior shrub, tree or flower. Following FIG. 7, grab the right side edge 6 of the drop cloth 1, and fold towards the left side of the cloth and gently place down over the already folded side of the canvas drop cloth. The 1″ high light weight barrier border 20 prevents the debris from falling off of the cloth FIG. 9 shows the Indoor and Outdoor Shrub, Tree and Plant Trimming and Pruning Canvas Drop Cloth 1 in its completed folded stage being held over a garbage pail 17 as it unfolds while being shaken by a user U (not illustrated but suggested) to allow all of the debris 18 to fall into the garbage pail 17.

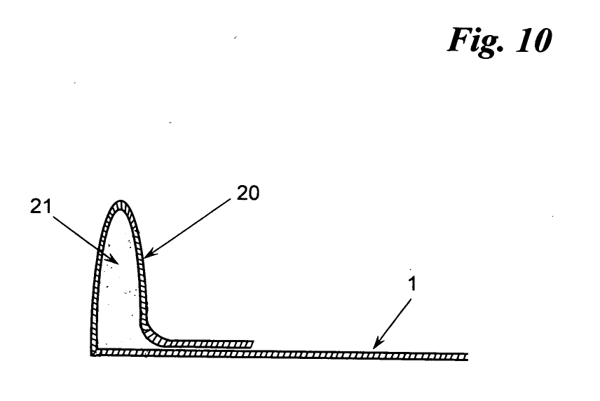

FIG. 10 shows the 1″ high×½″ wide barrier border 20 created by folding all the perimeter edges, the inner slit edges and the centrally located circle edge 1¾ inward to create the barrier border 20. Whereas, the barrier border 20 is stuffed with a light weight material cotton 21, or could be down or preferably any other light weight material. The barrier border 20 is double stitched on all edges to lock in the light weight material. Keeping the material light weight like cotton 21 or could be down, allows all the barrier borders 20 to be flexible and to keep their intended height to create a pan like affect.

1. A drop cloth comprising;
a planar body made from a canvas material, said body having an outer edge forming a square and a single slit from the outer edge leading to a hole centrally located therein forming an inner edge; said body further having a 1″ high light weight barrier border stuffed with cotton on the perimeter, as well as the inner edges and the centrally located hole; said body further having all edges doubled stitched.

2. A drop cloth as in claim 1, wherein said material is lightweight and flexible.

3. A drop cloth as in claim 1, wherein said material is water-resistant.

4. A drop cloth as in claim 1, wherein said material is water-proof.

5. A drop cloth as in claim 1, wherein said material is machine washable.

6. A drop cloth as in claim 1, wherein said drop cloth is easy to deploy and store.

7. A drop cloth as in claim 1, wherein said drop cloth is simplistic in design.
